(19) United States
(12) Patent Application Publication
(10) Pub. No.: US 2010/0071559 A1
(43) Pub. Date: Mar. 25, 2010

(54) MEMBRANES AND DEVICES FOR GAS SEPARATION

(76) Inventors: SYLVAIN MIACHON, LYON (FR); AWAD ALSHEBANI, LYON (FR); MARC PERA-TITUS, VILLEURBANNE (FR); JEAN-ALAIN DALMON, LYON (FR); SYLVIE LEMEULLE, LYON (FR); MAE MIACHON-LEMEULLE, LYON (FR); TELIO MIACHON-LEMEULLE, LYON (FR)

Correspondence Address: YOUNG & THOMPSON, 209 Madison Street, Suite 500, Alexandria, VA, 22314, US

(21) Appl. No.: 12/388,897

(22) Filed: Feb. 19, 2009

Related U.S. Application Data
(60) Provisional application No. 61/098,423, filed on Sep. 19, 2008.

(51) Int. Cl. B01D 53/02; B05D 3/00

(52) U.S. Cl. 96/113; 96/135; 427/372.2

(57) ABSTRACT

A membrane includes:
a hollow support having a plurality of pores
an active phase including a gaz-selective capting material embedded into the pores.

### BACKGROUND OF THE INVENTION

Carbon dioxide (CO₂) is regarded as one of the main promoters for climate change, accounting itself for ca. 70% of the gaseous radiative force responsible for anthropogenic greenhouse effect. Fossil fuel burning for energy production (electricity and heat) is the first world CO₂ emission source, reaching the level of 25000 MtmCO₂/year in 2003. According to the IEA-OCDE estimates, this sector accounted itself for 35% of world CO₂ emissions in 2002, with an annual increase about +33% in the period 1990-2002. The second sector in terms of CO₂ emissions is transport, involving 24% of the world emissions (2002) and showing a rapid increase in the last decade due to the increase of the automobile park.

This profile is, however, inversed in the case of France (see FIG. 1 showing CO₂ emissions in France per sector). As has been recently pointed out in an exhaustive report from the French Parliament and Senate, this ‘French specificity’ is mainly attributed to the great development of nuclear energy in this country, providing about 80% of the energy demands. As a matter of fact, CO₂ emissions due to fuel burning only accounted in France for about 9% of total emissions in 2004, while those ascribed to transport corresponded to ca. 39%. The tertiary sector (residential) and the ensemble agriculture-industry involved, respectively, 26% and 21% of the emissions. This particular CO₂ emission pattern in France translates into energy-related CO₂ emission rates per inhabitant as low as 1.7 tmCO₂/inhabitant (2003), one of the lowest in Europe (the mean rate for the EU25 in 2003 was 2.4 tmCO₂/inhabitant).

Despite the divergences among the European countries about the future of nuclear energy, it seems clear that its role will become more and more relevant in the global European strategy to diversify energy sources and reduce CO₂ emissions. The so-called 3^{rd} generation nuclear reactors (e.g., the European Pressurized water Reactor, EPR), much more efficient and safer than the present ones (2^{nd} generation), are expected to be operative by 2020 (4^{th} generation reactors are in current development). At long term, nuclear fusion instead of fission is expected to provide a complimentary source for energy production (the first demonstrative nuclear-fusion power station developed by the ITER consortium is expected to be fully operative in Cadarache, France, by the horizon 2060).

Different solutions have been proposed to reduce CO₂ emissions in vehicles to the level 120 gCO₂/km by 2012, as requested by the European Decision 2000/1753/EC. These solutions can be divided into three main groups: (i) decrease of fuel consumption by increasing energy efficiency of thermal propulsion systems, (ii) switch from petroleum-based energy sources to more sustainable ones (e.g., biofuels, fuel cells and electrical systems), and (iii) CO₂ capture, transport and storage. FIG. 2 summarizes the main propulsion possibilities and the required energy sources to mitigate CO₂ emissions in vehicles.

The increase of energy economy in thermal systems, as well as the reduction of atmospheric emission of priority pollutants and greenhouse gases, is the major concern of car manufacturers at present. The main strategies involve first the increase of compression rates of conventional thermal systems. The adaptation of thermal engines to other fuels, such as liquefied petroleum gas (LPG) and natural gas vehicle (NGV), is another possibility, allowing prospected reductions up to 25% in CO₂ emissions. Hybrid systems combining a thermal engine (preferentially diesel) and an electrical engine have been proposed as well and some models are already available in the market (e.g., Toyota Prius). The use of these systems is, however, limited due to the insufficient storing capacity of accumulators, and to the technical complexity of on-board electrical production.

Alternative propulsion technologies based on fuel cells using hydrogen as energy vector have been considered for long and appear to be a serious option to mitigate CO₂ emissions in vehicles at mid term. Hydrogen can be directly obtained from naphthas, or industrially produced from syngas (CO+H₂) by steam reforming of coal, oil residues, natural gas and biomass (see FIG. 2, which represents the synthesis of liquid fuels and hydrogen as energy vectors in automobile propulsion) with subsequent water-gas shift reaction. Of course, the overall carbon balance of fuel cells is not zero, since the water-gas shift reaction produces CO₂. Despite the seductive character of fuel cells, their commercialization does not seem to be immediate. Indeed, their exorbitant costs, as much as 6000-8000 [symbol] /km compared to those of thermal engines (about 30-50 [symbol] /km), as well as the extremely low volumetric density of hydrogen, make it difficult to devise a large-scale implementation of fuel cells in vehicles before the horizon 2020.

In light of all the above stated considerations, hardly any alternative technology to conventional thermal systems relying on the liquid-fuel combustion appears to be competitive at short and mid terms for propulsion in vehicles. Even in a scenario characterized by an oil barrel price higher than 300 US$, liquid fuels might be still produced at comparable prices from syngas by Fischer-Tropsch (FT) synthesis (see FIG. 2). The important stocks of carbon and natural gas (for more than 200 years in the case of carbon at the current production rates), ensure the supply of liquid fuels produced via ‘carbon-to-liquids’ and ‘gas-to-liquids’ FT processes to the world markets at comparable costs.

Furthermore, biofuels, either produced by alcoholic fermentation (e.g., bioethanol), or by the ‘biomass-to-liquids’ FT process, are expected to play a more and more relevant role in the coming years in the European energy strategy. Although biofuels could allow a long-term reduction up to 80% of CO₂ emissions taking into account the whole life cycle of carbon (emitted CO₂ can be reabsorbed by plants through photosynthesis), they are actually burned in thermal systems as in the case of fossil-based fuels. Therefore, they are not expected to contribute much at short-term to the mitigation of CO₂ emissions by mobile sources.

At this point, and taking into account that liquid-fuel-based thermal engines will not probably lose their supremacy as propulsion technology for at least several decades, the question that arises is: ‘how to decrease drastically CO₂ emissions in vehicles without significant technological modification of thermal systems, and therefore help mitigating the environmental impact of transport?’ The most reasonable answer is, on the guidance of some recent technical reports, to proceed with CO₂ capture, transport and sequestration. Several technologies are available or under study for CO₂ capture in stationary post-combustion emission sources, such as power plants (e.g., adsorption with amines, cryogenic separation, pressure- and thermal-swing adsorption). Nevertheless, none of technologies appear to be suitable for CO₂ capture in mobile sources due to their high-energy costs (>4 GJ/tm CO₂ removed for amine adsorption), and their large space requirements. The emergency of specific post-combustion CO₂ capture solutions especially conceived for vehicles, involving reasonable energy costs in terms of power over consumption and low volume, appears therefore to be imperative. Using an on-board CO₂ capture unit, new vehicles could reduce notably their CO₂ emissions without changing the propulsion technology.

The use of hollow fibre geometry has long been a solution to improve the performance of membrane-based separation processes. In liquid phase (e.g., water treatment), polymer hollow fibres are commonly used at the industrial scale. Similarly, in gas separation, they are widely used in refinery or ammonia production industries for instance. Low cost, associated with large surface/volume ratios (>1000 m²·m⁻³), make them the configuration of choice for a large number of membrane-based applications.

Until now, most zeolite membranes have been implemented in single tubes, multichannel tubes and monoliths or planar geometries. In Husaim and al., “Mixed matrix hollow fibre membranes made with modified HSSZ-13 zeolite in polyetherimide polymer matrix for gas separation” J. Membr. Sci. 288 (2007), 195, some zeolite—polymer mixed matrix materials have also been described in hollow fibre form, showing some gas perm selectivity, but permeances in the order of nmol·m⁻·s⁻¹·Pa⁻¹, typical of polymer membranes. Other works have been reported on purely inorganic materials. Smith et al., “Preparation of hollow-fibre composite carbon-zeolite membranes”, Micropor. Mater. 4(1995), 385, have shown the preparation of zeolite membranes based on carbon hollow fibres, but with neither permeation nor separation tests. More recently, Richter et al. “Preparation of zeolite membranes of the inner surface of ceramic tubes and capillaries”, Sep. Purif. Technol. 32 (2003), 133, published a work based on ‘capillaries’ (i.e. tubes of about 4 mm diameter), with single gas permeances around 0.5 μmol·m⁻²·s⁻¹·Pa⁻¹, but no quality testing was provided further, making it very difficult to assess for membrane quality. Moreover, this work keeps the idea of using asymmetric supports. Finally, the structure shown in that work remains a relatively thick film-like structure (30 μm). Xu et al., “Synthesis of NaA zeolite membrane on a ceramic hollow fiber”, J. Membr. Sci. 229 (2004), 81, presented the synthesis of zeolite NaA membranes on 0.4 mm diameter ceramic hollow fibres, showing a continuous 5-μm film offering typical single permeances of ˜0.03 μmol·m⁻²·s⁻¹·Pa⁻¹. Membrane quality was estimated by pure gas permeance only, which is difficult to use for reliable defect searching, as explained in Miachon and al., “Nanocomposite MFI-alumina membranes via pore-plugging synthesis: Specific transport and separation properties”, J. Membr. Sci 298 (2007), 71, hereby incorporated by reference in its entirety.

The concept of Nanocomposite structure was proposed in recent works for MFI/ceramic membranes in Miachon and al., “Nanocomposite MFI-alumina membranes via pore-plugging synthesis. Preparation and morphological characterisation”, J. Membr. Sci. 281 (2006) 228, in van Dyk and al., “Xylene isomerization in an extractor type Catalytic Membrane Reactor”, Catal. Today 104 (2005) 274, and in Ciavarella and al., “Experimental study and numerical simulation of hydrogen/isobutane permeation and separation using MFI-zeolite membrane reactor”, Catal. Today 56 (2000) 253, which are hereby incorporated by reference in their entirety.

### SUMMARY OF THE INVENTION

To meet these objectives, we propose a membrane comprising:
a hollow support having a plurality of pores
an active phase comprising a gaz-selective capting material embedded into the pores.

Advantages of some embodiments include the fact that these embodiments can be highly resistant to thermal shocks, environmentally friendly, and offer high fluxes and promising CO₂ separation factors. The suitability of this material, and the technico-economical feasibility of the solution proposed in terms of energy economy and CO₂ emission reduction in case of heavy vehicles (>3500 kg) will be exposed. We also address the main improvements in terms of membrane flux and selectivity that are accomplished to design an optimized a unit for in situ CO₂ capture and liquefaction in heavy vehicles.

Nanocomposite MFI/ceramic fibres might offer several advantages compared to conventional film-like zeolite membranes. In the nanocomposite architecture, the active phase is not made of a film on the top of a porous support, but rather embedded into the support pores via pore-plugging synthesis. This not only allows individual membrane defects not to exceed the size of the support pores, but also provides a better mechanical resistance, as well as a higher resistance to thermal shocks. Moreover, the thermal behaviour of nanocomposite membranes prepared so far differs from their film-like counterparts.

The characteristics mentioned above, all eventually translating into cost for the final application, make nanocomposite MFI/ceramic fibres ideal candidates for carbon dioxide separation, for which MFI has shown to be perm selective in certain conditions. The supports used (1.7 mm diameter) can be larger than common polymeric hollow fibres. However, ceramic membranes show higher permeance together with higher thermal and mechanical stability. Moreover, the cost of the starting support, because of its symmetrical structure, would not be a limiting factor.

The membrane surface/module volume ratio is one of the main criterion in designing separation units. This parameter can be increased by one order of magnitude when dropping the membrane tube diameter from the cm to the mm scale. Alumina hollow fibres have been used as supports and submitted to pore-plugging MFI zeolite synthesis. An alumina-MFI nanocomposite structure, showing no surface film, has been obtained, as observed by SEM and EDX analysis and confirmed by high temperature variation of H₂ and N₂ permeances. Maxwell-Stefan modelling provides an equivalent thickness lower than 1 μm. The membrane quality has been assessed by gas separation of n-butane/H₂. A first application to CO₂/H₂ separation has been achieved, reaching separation factors close to 10. Such a system, based on cheap symmetric supports, could lead to an important decrease in module costs for gas separation applications.

### BRIEF DESCRIPTION OF THE DRAWINGS

FIG. 1 is a diagram showing CO₂ emissions in France per sector,

FIG. 2 is a diagram summarizing the main propulsion possibilities, and the required energy sources to mitigate CO₂ emissions in vehicles,

FIGS. 3a to 3e are pictures showing fibres mounted into a mechanical support tube,

FIG. 4 is a typical bubble-flow graph,

FIG. 5 is a graph showing XRD patterns of a crushed fibre after zeolite synthesis and calcination and before synthesis,

FIG. 6 is a graph showing cumulated (left axis) and derivative (right axis) volumes as a function of pore diameter,

FIG. 7 is a graph showing the N₂ adsorption isotherm à 77K on crushed fibres before (bottom) and after (top) zeolite synthesis,

FIGS. 8a to 8c are SEM micrograph pictures of the fibres in cross section before zeolite synthesis,

FIGS. 9a to 9f are similar views after zeolite synthesis,

FIG. 10 is a graph showing EDX patterns of different materials,

FIG. 11 is a graph showing the variation of H2 and N₂ single gas permeance as a function of temperature,

FIG. 12 is a graph showing the evolution of pure H2 and CO₂ permeance of fibres before Nₐ exchange,

FIG. 13 is a graph showing the evolution of gas flux of butane and H2 during the butane/H2 separation with temperature,

FIG. 14 is a graph showing the evolution of CO₂/H2 separation factor with feed pressure,

FIG. 15 is a graph showing the performance of the samples ZSM-5 (1) for separation of n-butane/H2 mixtures,

FIG. 16 is a graph showing the evolution of SF6 and the molar flux with temperature of the separation of a SF6/N2 mixture,

FIG. 17 is a graph showing the evolution of the CO₂/N₂ separation factor and CO₂ and N₂ mixture permeances with the He sweep gas flow,

FIGS. 18 and 19 are graphs showing the evolution of the CO₂/N₂ separation factor in the separation of CO₂/N₂ mixture as a function, respectively of CO₂ feed composition and temperature,

FIG. 20 is a diagram showing the scheme of the hollow-fibre base unit for in situ CO₂ capture,

FIG. 21 shows the evolution of the molar function of CO₂ in the permeate with the separation factor for a CO₂ permeance of 0.5 and 1.0,

FIG. 22 is a schematic view of a membrane, and

FIG. 23 is a schematic cross-section of view inside the membrane of FIG. 22.

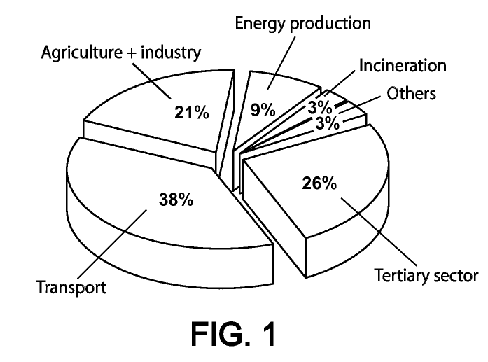

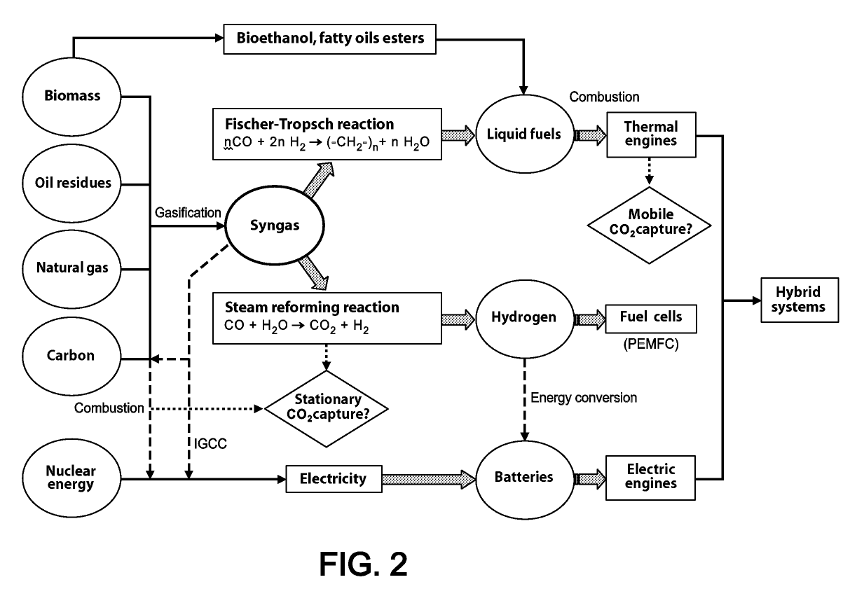

On the drawings, the same references correspond to like or similar elements.

### DETAILED DESCRIPTION

### Experimental

Ceramic Support

Ceramic hollow fibres can be manufactured by a wet spinning process, such as, for example, described in Goldbach and al., “Keramische Hohlfaser-und Kapillamembranen”, Keram. Z. 53 (2001) 1012, enclosed hereby by reference.

Alumina particles (SUMITOMO α-Al₂O₃, mean particle size: 0.33 μm) were mixed with a solution of Polysulfone (SOLVAY UDEL P-3500) in N-Methylpyrrolidone (MERCK) and were ball-milled for 16 h. This slurry was spun through a spinneret into a water bath where the polymer precipitated incorporating the ceramic particles. The resulting green fibres were cut into 30-cm pieces and sintered to full ceramic hollow fibres. The properties of the final fibres are summarized in Table 1.

TABLE 1
Properties of the ceramic hollow fibres used as
supports for zeolite membrane synthesis in this work

| Mean outer diameter | 1.65 | mm |
|---|---|---|
| Mean wall thickness | 230 | μm |
| Mechanical stability (3-point bending test) | 112 | MPa |
| Porosity | 43% | |
| First bubble point | 2.5 | bara |

Only hollow fibres displaying first bubble points around 120 kPa, corresponding to an average crossing pore size smaller than 0.2 μm, were used for synthesis.

The support quality was tested using a method based on gas-liquid displacement. In this method, the porous fibres, after careful sealing on a metal connector using epoxy resin, were first immersed in ethanol to allow the liquid fill up all the porosity. This method consists first of bubble point pressure test by applying an increasing pressure to inside the tube in dead-end mode. According to Laplace Law, the pressure of the first bubble allows the determination of the largest pore size of the fibres. The further increase of the permeating gas flux with the gas overpressure (up to 4 bar by 5 min with 0.5 to 1-bar steps) allowed a relative comparison of fibres of similar structure, with regards to the importance of subsequent smaller defects in the fibres. These measurements were compared to those obtained on conventional 10-mm diameter multilayer tubes used in previous studies. Hereinafter this test will be referred to as ‘bubble flow measurement’.

It should be mentioned that other material could be used for the manufacture of the hollow support, such as inorganic materials, or polymers.

Zeolite Synthesis

Crystalline microporous aluminosilicates are used for zeolites. For example, MFI zeolite is used. It is hydrothermally synthetized.

The structure directing agent (SDA, 1 M tetrapropylammonium hydroxide, TPAOH, from Aldrich), and the silica source Aerosil 380 (Degussa) were mixed and slightly diluted in deionised water to form a clear solution of molar composition 1.0 SiO₂:0.45 TPAOH:27.8 H₂O (pH close to 14) before a 3-day maturation period at room temperature under stirring.

Nine 23-cm long ceramic hollow fibres were then inserted into a Teflon®-lined autoclave containing about 25 mL of precursor solution, and submitted to an interrupted hydrothermal synthesis at 423 K for 4 days. The amount of precursor was calculated considering the ratios precursor volume/porous volume/membrane surface.

The pH, the Si and Al composition and/or the type of precursor solution might be changed to modify the nucleation kinetics or crystal growth.

The fibres were then washed and dried at 373 K for 12 h. Before calcination at 773 K in air for 4 h, a single N₂ permeation test showed no gas permeance (i.e. below the detection limit of about 10⁻¹⁰ mol·m⁻²·s⁻¹·Pa⁻²).

Other zeolites could be envisaged such as SAPO-34. Even other CO₂-selective material could be embedded in the pores of the support. An example of such CO₂ material could for example be a mesoporous silica (for example MCM) grafted with a CO₂-selective group (for example amine groups).

Thus, a nanocomposite material is obtained.

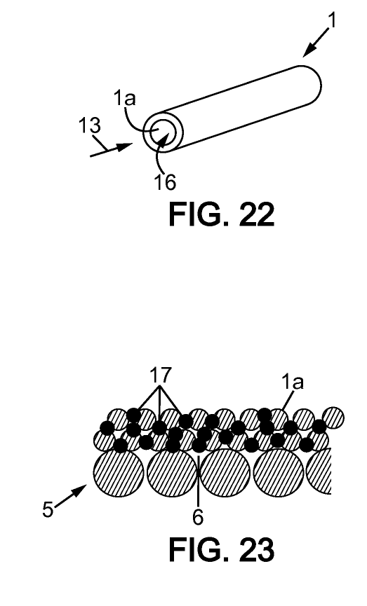

As can be seen on FIG. 22 and 23, the resulting fibre 1 can have the shape of a hollow-tube comprising an inner surface 1a defining an inner lumen 16. The lumen 16 has an opening to receive a flux of incoming gas 13. As more visible on FIG. 23, the fibre 1 defines a nanocomposite structure wherein pores or holes 6 of the support 5 are filled with a gaz-selective capting material 17, such as the zeolite crystals.

Physical Characterisations

The chemical composition of the fibres before and after synthesis was determined by Inductively Coupling Plasma (ICP) elemental analysis (Activa Jobin Yvon) with previous dissolution in 20 wt. % HCl.

The structure of the synthesised zeolite material was analysed by X-ray diffraction (XRD) using a Philips PW1050/81 diffractometer (Cu Kα1+2 radiation). The analyses were performed on powders obtained from crushed fibres before and after hydrothermal synthesis.

X-ray diffraction (XRD) confirmed that pure H-ZSM-5 was the only zeolitic phase on the fibre after synthesis.

Mercury intrusive porosimetry was used to estimate the reduction of macroporosity of the support after hydrothermal synthesis. A Micromeritics Autopore IV 9500 penetrometer was used with samples of 156 mg and 112 mg, respectively, for the fibres before and after zeolite synthesis.

The textural properties of the crushed fibres before and after zeolite synthesis were obtained from N₂ adsorption isotherms at 77 K using a Micromeritics ASAP 2020 sorptometer. BET surface areas were determined from recorded adsorption data in the range 0.30≦P/P°≦0.50.

The morphology of the fibres was inspected by scanning electron microscopy (SEM) using a Hitachi S-800 microscope operating at 10 kV. The samples were obtained by breaking the samples in small pieces. Saw cutting was not used to avoid modifications in the structure during cutting. The local and average Si and Al concentration across the fibres before and after hydrothermal synthesis on the same equipment by energy dispersive X-ray analysis (EDX) using a 1-μm microprobe (Edax Phoenix) with SETW polymer window parallel to the membrane surface.

Hollow Fibre Mounting

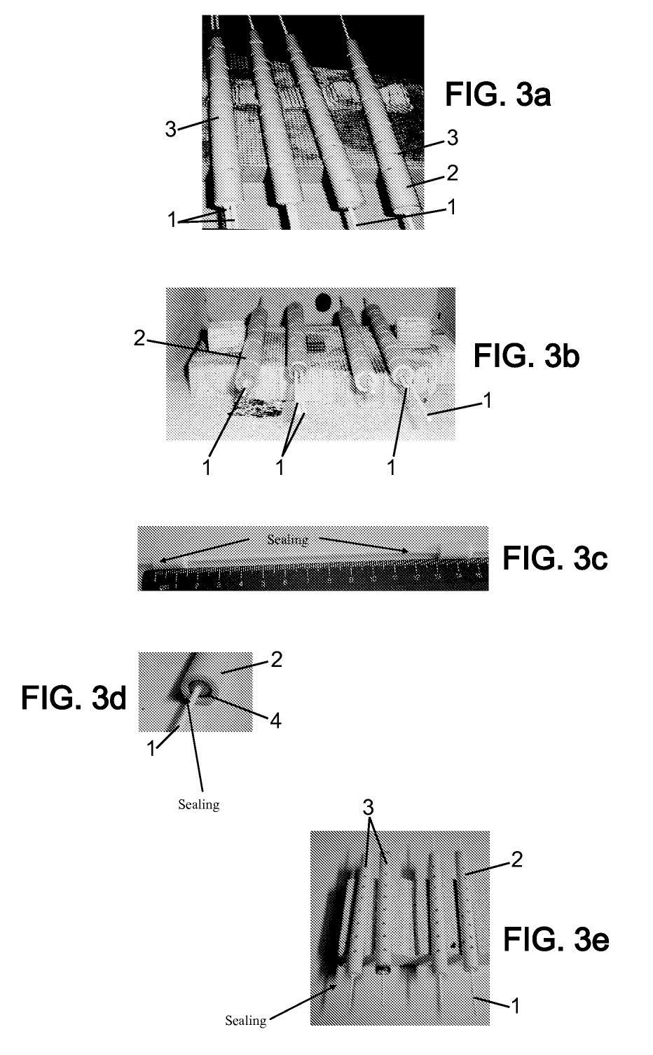

Practical mounting and gas sealing of the fibres was then achieved. As a matter of fact, the sealing should withstand the temperature (i.e. 623 K). However, the sealing material had to be processed at temperatures sustainable for the MFI material (i.e. below 1000 K), as the hollow fibres were mounted after hydrothermal synthesis. A glaze, based on a suspension of oxides of aluminium, silicon and sodium in high concentration in water was used. It was used to immobilize the fibre(s) 1 into a dense alumina tube 2 perforated with small holes 3, in order to allow easy gas circulation (i.e. sweep gas flow) around the fibre(s), as shown in FIG. 3a to 3e.

On these figures, fibres 1 are shown mounted into their mechanical support tube 2, showing the glaze 4 fired after hydrothermal synthesis.

This approach is valid for a single fibre and has been extended up to 4 fibres.

This ensemble ‘fibre in tube’ was then mounted in a more conventional membrane stainless steel module initially designed for 10-mm diameter tubular membranes. Graphite cylindrical o-rings (Cefilac-Fargraf) were used to seal the support tubes to the module.

Before any transport measurement, the hollow fibres were subjected to an in situ high temperature desorption pretreatment at 673 K under 20 NmL·min⁻¹ N₂ flow at both sides with a heating ramp of 1 K·min for at least 4 h to remove adsorbed species.

In a variant embodiment, after the whole mounting, some fibres were subjected to in situ ion exchange to introduce Na⁺ in the MFI structure. After careful wetting of the fibres, a solution of NaCl (1 M) was pumped along the lumen of the fibres during 24 h, while keeping the permeate side of the membrane under N₂ flow. After this period, the module was rinsed in water to avoid salt deposition on the fibres. EDX analysis was used to evaluate the rate of cation exchange on the fibres.

Other cations than Na⁺ could be used. They modify the adsorption of the zeolite. Pore and cavity sizes are modified by these cations and hence adsorption forces.

Single Gas Permeance

Single gas (H₂, and N₂) permeance tests were carried out in the temperature range 293-723 K using steady-state steps to assess for the high temperature behaviour of the separative phase and therefore for the nanocomposite structure of the membrane. Further, single gas (H₂ and CO₂) permeance tests were carried out in the same temperature range to assess for the temperature behaviour of the nanocomposite material before and after ion exchange.

In these tests, the feed pressure was kept close to 125 kPa and the transfibre pressure ca. 3.2 kPa. A regulating valve at the outlet of the retentate compartment was used to adjust the internal pressure. Another regulating valve at the outlet of the permeate stream was used to control the transfibre pressure difference.

In order to evaluation the flux and permeance of the fibre, the surface area used for calculation was obtained using the average diameter of the cylinder (1.53 mm, i.e. 5.5 cm² for a 15-cm long fibre).

Mixture Separation

Three gas separations were carried out. The room temperature separation of n-butane/H₂ at low temperature was used for quality testing. In such a mixture, the strong adsorption of n-butane in the MFI pores will block H₂ permeation. Therefore, any mesoporous defect in the membrane would locally inverse the selectivity (turning to Knudsen mechanism), and reduce the separation factor. This mixture separation is then more defect-sensitive than other separations. The room temperature of separation of SF₆/N₂ was also performed. These separations were carried out further with increasing temperature, in Wicke-Kallenbach mode: the gases were diluted in dry N₂ (15 v/v. %)or He (15v/v. %), respectively. The feed was kept at about 125 kPa, at a flow rate of 80 Ncm³/min, with a counter-current sweep gas of also 80 Ncm³/min. The transfibre differential pressure was kept at 3.2 and 0.4 kPa, respectively.

Moreover, the fibres were also tested for separation of CO₂/H₂ undiluted equimolar mixtures (204 Ncm³/min feed and 12 Ncm³/min N₂ sweep, 700 Pa transfibre total pressure) in order to survey the application of these materials for CO₂ separation. Keeping equimolar feed, the total feed pressure was varied from 100 to 340 kPa.

The fibres were also tested for separation of CO₂/N₂ non-diluted mixtures (204 Ncm³/min feed and 12 Ncm³/min He sweep, 0.7 kPa transfibre total pressure). The surveyed ranges of the main operational variables were: temperature, 298-723 K; feed pressure, 101-404 kPa; CO₂ feed concentration, 10-80%.

In both separations, gas flows and feed compositions were controlled by mass-flow controllers (Brooks, type 5850TR and 5850E). A gas chromatograph (HP 5890), using both TCD and FID detectors, was used to measure feed, retentate and permeate compositions. In general terms, the separation factor (Sf) of gas A over gas B (butane over H₂, n-butane over H₂, CO₂ over H₂, or CO₂ over N₂) was calculated as the permeate-to-feed composition ratio of the first gas, divided by the same ratio of the second one.

### Results

Quality Testing of Fibre Supports

The quality of the support (i.e. the amount and size of larger defects) was shown to be of crucial importance to the final zeolite membrane quality. To this end, prior to hydrothermal synthesis, the fresh fibres were subjected to bubble point tests to assess for the presence of large defects.

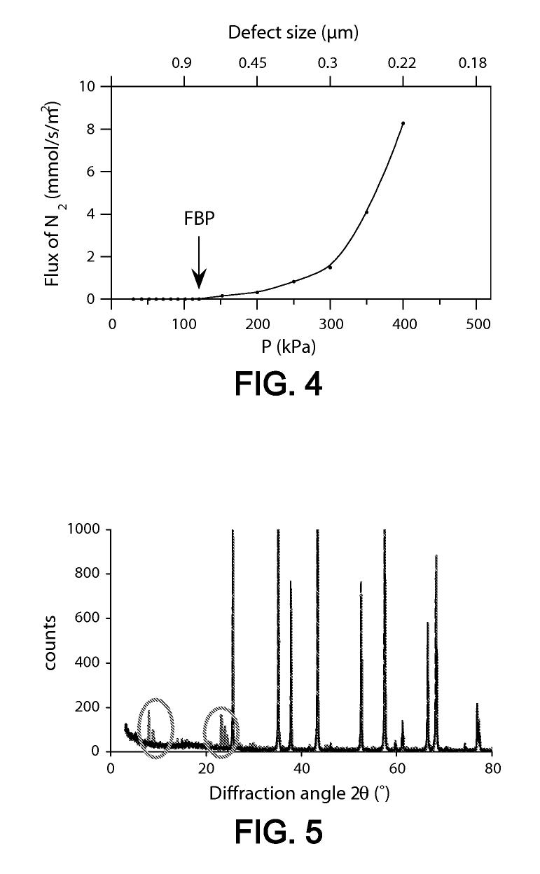

FIG. 4 shows a typical bubble flow graph obtained, as the variation of N₂ flow through an ethanol soaked fibre support (FBP, First Bubble Point). As can be seen, after a first bubble point (FBP) at 120 kPa (ΔP or ²P), comparable to values on tubular supports used in previous studies), a sharp increase is observed in the N₂ flux. This indicates that the average crossing pore size is smaller than 0.2 μm, in good keeping with the known particle size (0.33 μm) of the alumina raw material used to prepare the fibre.

Physical Characterisations

Weight Uptake & Elemental Analysis

The weight measurement just after synthesis and calcination provided a direct uptake of ca. 10% of the fibre mass.

Elemental analysis of the fibre showed no Si in the fibre before zeolite synthesis, and 51.5±0.3 wt. %. of Al (close to the theoretical 52.9 wt. % of Al₂O₃). After synthesis, the Si and Al compositions were, respectively, 4-5 and 44-46 wt. %.

X-ray Diffraction

FIG. 5 shows XRD patterns of a crushed fibre after zeolite synthesis and calcination. The circles refer to peaks related to the MFI phase, which are absent of the XRD patterns for the fibre before synthesis.

As can be seen, pure MFI was the only zeolitic phase on the fibre after synthesis, without evidence of a significant presence of amorphous silica.

Macroporosity

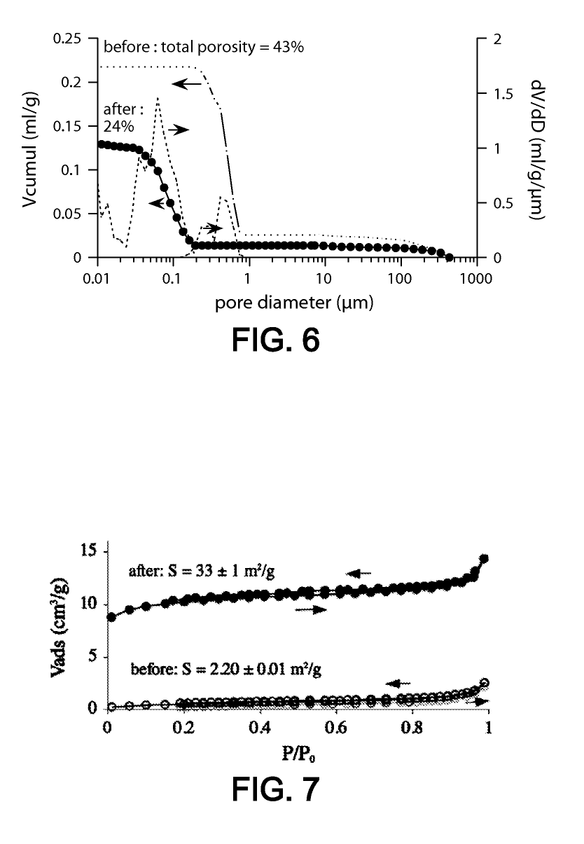

FIG. 6 shows cumulated (left axis) and derivative (right axis) volumes as a function of pore diameter obtained from mercury porosimetry. [Open symbols: support fibre, full symbols: zeolite—alumina fibre].

FIG. 6 shows the evolution of macroporosity, as measured by mercury porosimetry. Claim that considering the small mass of both samples, these measurements should be regarded as indicative. However, one can see that the total porosity (for pores between 0.01 and 400 μm) of the sample was reduced from about 43% before zeolite synthesis down to about 24% just afterwards. Moreover, after synthesis, the pore size distribution is shifted towards smaller pores, from an important contribution centred between 0.26 and 0.46 μm to a bit less than 0.1 μm. Please claim that (i) the mass of sample is limited and (ii) the pores observed here can be crossing as well as dead-end pores. Therefore, no qualitative conclusion can be driven from the derivative curves.

Microporosity

FIG. 7 shows the N₂ adsorption isotherm at 77 K on crushed fibres before (bottom) and after (top) zeolite synthesis. The N₂ isotherm after synthesis shows a rapid N₂ uptake at low P/P⁰ ratios, followed by a plateau typical of a Type I isotherm. Moreover, the N₂ adsorption loadings are ca. 7 times higher after zeolite synthesis than for the fresh fibres.

Electron Microscopy

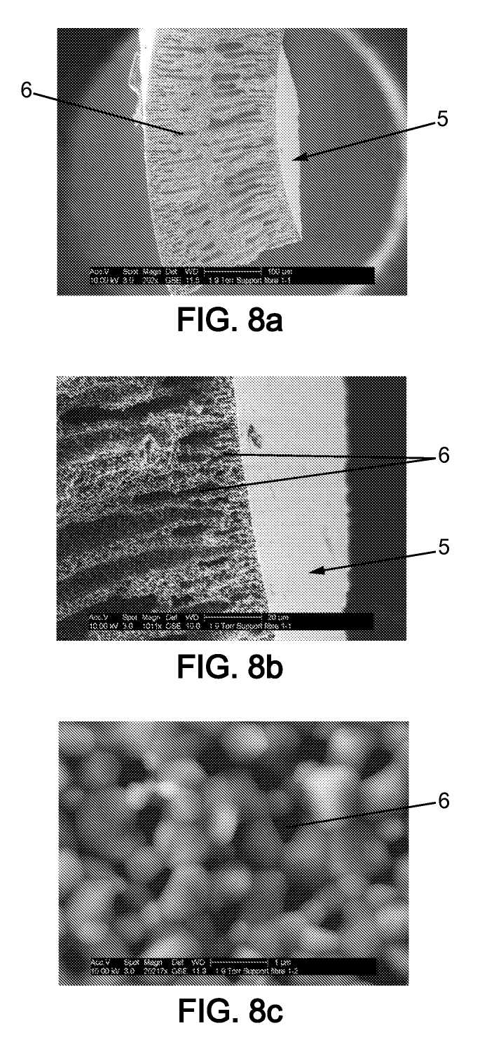

FIG. 8a to 8c shows cross section SEM micrographs of the support 5 before zeolite synthesis. The support exhibits very large pores 6 or holes actually restricting the equivalent thickness to a fraction of the apparent wall thickness (about an order of magnitude, close to 20 μm). The higher magnification micrograph reveals a pore size of about 0.3-0.4 μm (FIG. 8c) in an area located between the largest holes.

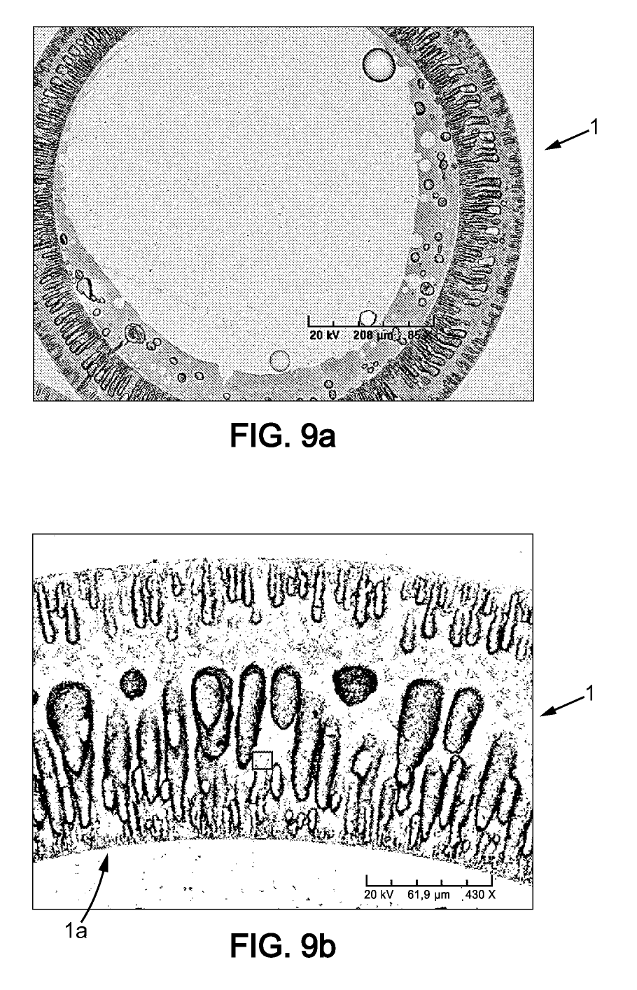

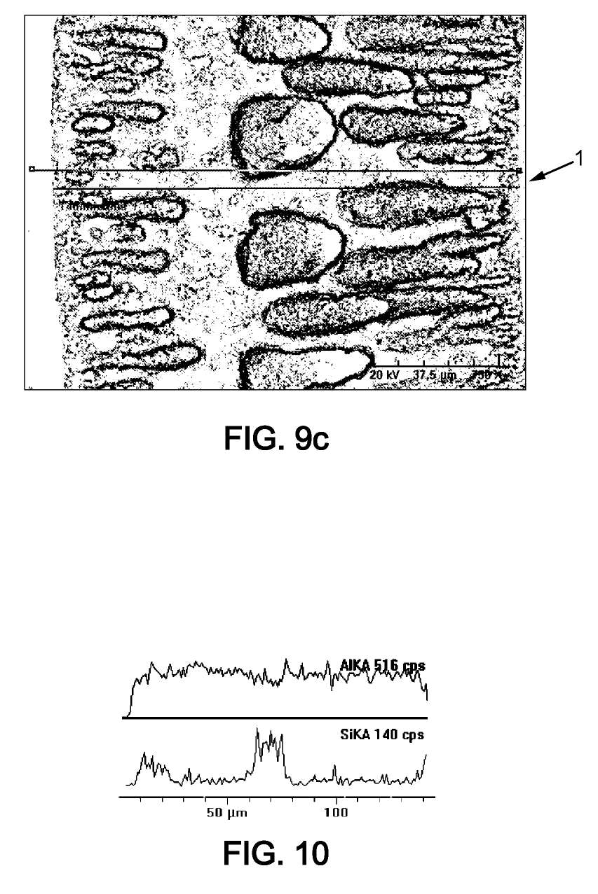

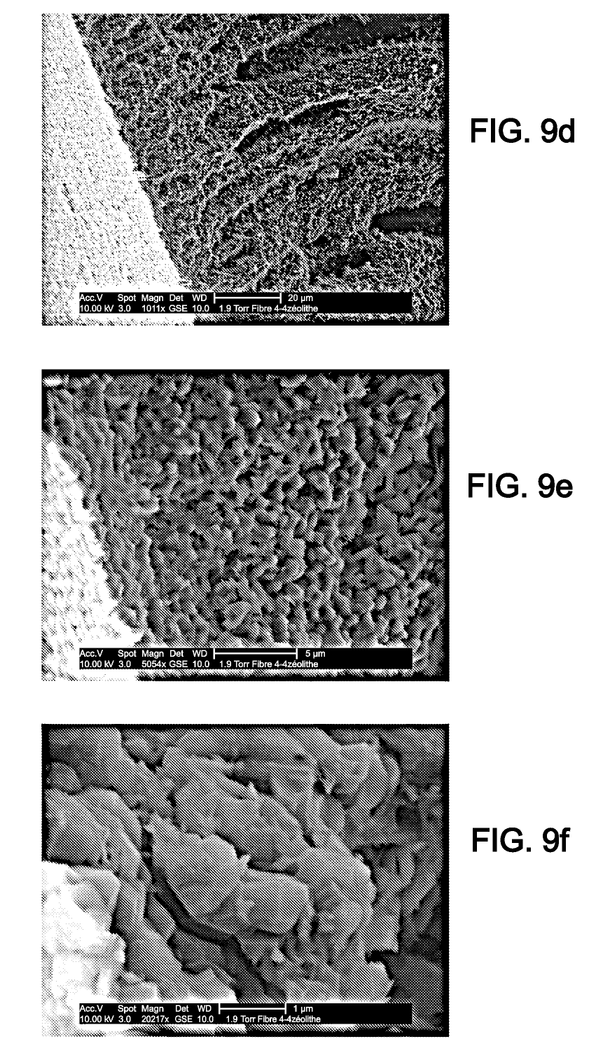

FIG. 9a to 9f show similar views of the hollow fibre 1 after zeolite synthesis in a growing magnification order.

In any case, no continuous film is formed on top of the support inner surface 1a (which is the surface which is to be submitted to the inflow) after synthesis.

The views show both a part of the cross section of the fibre and some of its internal surface. The grains of the alumina support can be clearly identified, and no surface film of zeolite crystals can be observed, even at higher magnifications (FIG. 9f). In this last view, crystalline features can be recognised, where before synthesis the support pores were located.

Further EDX analyses were carried out on a large number of regions to investigate the—material hosted in the α-alumina fibres after synthesis.

The EDX patterns plotted in FIG. 10 confirm that no siliceous material is formed outside the support porosity, and that a great amount of the material is located in the support porosity within the first 30 μm from the inner surface. An important amount of material is also located at about 80 μm from the inner surface, probably in the larger pores. The Si/Al ratio of the fibres is about 0.13, reflecting that an important proportion of the support macroporosity ascribed to smaller-sized pores is filled by the zeolite material.

As expected, the support exhibits only the presence of Al and O before synthesis, while after synthesis and calcination, the fibre shows significant amounts of Si (8-12 wt. %) on the cross section in homogeneous regions (i.e. out of the larger holes, those showing large amounts of disjoined large MFI crystals).

H₂ and N₂ Permeance

A first series of tests were carried out using single gas permeation experiments for N₂ at room temperature after in-situ thermal treatment at 673 K for 4 h. The permeance of fibre supports, before zeolite synthesis, was about 50 μmol·m⁻²·s⁻¹·Pa at 1.0 bar average pressure. On nanocomposite MFI/alumina fibres, the permeance was reduced to about 1 μmol·m⁻²·s⁻¹·Pa⁻¹.

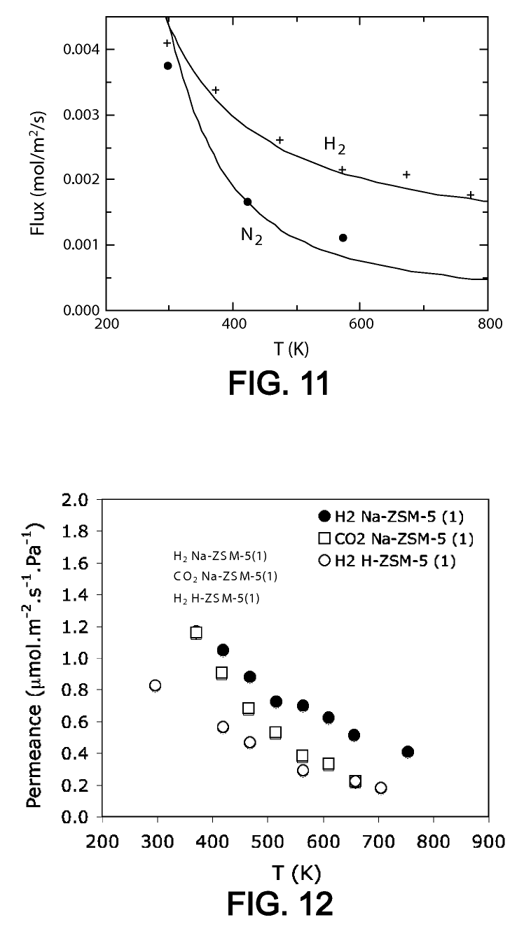

FIG. 11 shows the variation of H₂(+) and N₂(.) single gas permeance through a nanocomposite MFI/alumina fibre samples as a function of temperature, together with the Maxwell-Stefan (MS) fittings according to the following expression:

$$N = \frac{{c}_{sat} ρ ɛ {D}_{o}^{∞}}{τ l} ln [ \frac{1 + \frac{{P}_{R}}{{P}^{o}} exp ( \frac{Δ {S}_{ads}^{o} - R}{R} - \frac{Δ {H}_{ads}^{o}}{RT} )}{1 + \frac{{P}_{P}}{{P}^{o}} exp ( \frac{Δ {S}_{ads}^{o} - R}{R} - \frac{Δ {H}_{ads}^{o}}{RT} )} ] exp [ - \frac{{E}_{D}}{RT} ] \qquad ( 2 )$$

with (parameter values taken from [5]):
R: ideal gas constant (8.314 J·mol⁻¹·K⁻¹)
cₛₐₜ: concentration of the gas in MFI crystals (5.4 mol·m⁻³ for both gases)
ρ_{MFT}: density of MFI (1700 kg·m⁻³)
ε: porosity of the nanocomposite MFI/alumina structure (0.13)
D_{C}^{∞}: Maxwell-Stefan diffusivity at zero coverage (H₂: 1.8·10⁻⁸ m²·s⁻¹, N₂: 0.4·10⁻⁸ m²·s⁻¹)
τ: tortuosity (1.2)
   l: equivalent MFI thickness (m, fitted parameter)
P_{R}: retentate pressure [Pa]
P_{P}: permeate pressure [Pa]
P°: reference to atmospheric pressure (101325 Pa)
   ΔS°_{ads}: standard adsorption entropy (H₂: −43, N₂: −50 J·mol⁻¹·K⁻¹)
   ΔH°_{ads}: standard adsorption enthalpy (H₂: −5900 J·mol⁻¹, N₂: −13800 J·mol⁻¹)
   E_{D}: diffusion activation energy (H₂: 2000 J·mol⁻¹, N₂: 4000 J·mol⁻¹)

The conditions were retentate pressure 105 to 125 kPa and transfibre pressure 3.2 kPa.

As can be seen, the permeance of both gases shows a continuous decrease with temperature. The MS fittings reflect an equivalent MFI thickness close to 1 μm. Claim that the observed variations show no indication of permeance increase at higher temperature up to 723 K.

Pure H₂ and CO₂ Permeance Before and After Na-exchange FIG. 12 shows the evolution of pure H₂ and CO₂ permeance of MFI-alumina fibres before Na-exchange.

Conditions: retentate pressure, 104 kPa; transfibre pressure, 3.2 kPa; He sweep flow, 150 NmL/min.

As can be seen, for both gases, the permeance is about 1 μmol·m⁻²·s⁻¹·Pa⁻¹. Note that this permeance is 1-2 orders of magnitude higher than the value than can be obtained on conventional film-like membranes [17-19], probably due to the much lower MFI equivalent thickness in the former case (up to 1 μm). Moreover, the permeance of both gases shows a continuous decrease with temperature, with no indication of permeance increase at higher temperature up to 723 K, as expected for a nanocomposite architecture.

The amount of intercrystalline defects of the synthesized MFI material is fairly low, as inferred from the low viscous contribution to N₂ permeance after calcination (up to 2%), obtained from the slope of N₂ permeance with the average pressure (not shown).

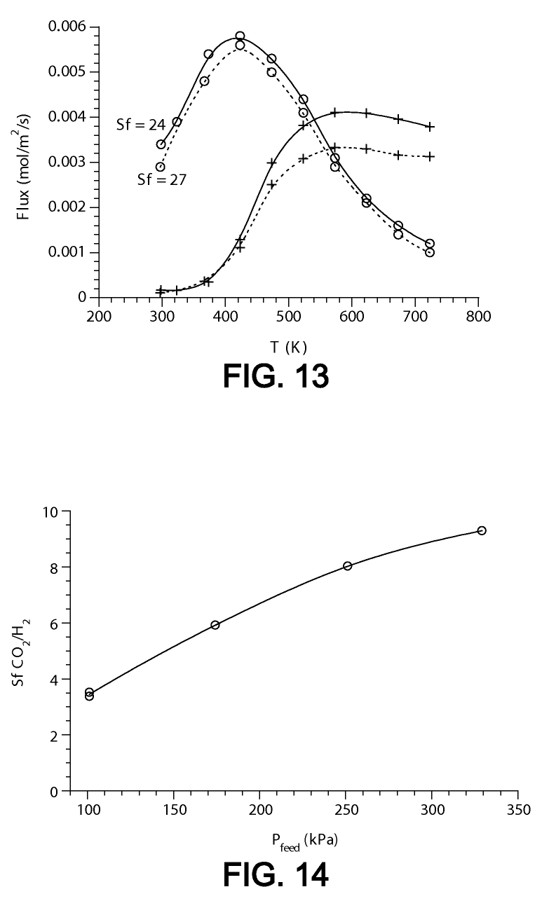

Separation of butane/H₂ and CO₂/H₂ Mixtures FIG. 13 shows the evolution of gas flux of butane and H₂ during butane/H₂ separation with temperature in an equimolar mixture through two nanocomposite MFI/alumina fibres (full and dotted lines) after pretreatment at 673 K for 4 h. Symbols: (o), butane flux; (+), hydrogen flux. Conditions: retentate pressure 125 kPa and transfibre pressure 0.4 kPa.

These are shown on the same fibre sample than on FIG. 11, together with a similar result obtain on another sample.

The molar flux of both gases is shown as a function of temperature, from 300 to 723 K. Claim that for both gases, the molar flux shows a decreasing trend at higher temperature. The separation factors (Sf) in favour of butane at low temperature are 24 and 27.

FIG. 14 shows the evolution of CO₂/H₂ separation factor with feed pressure in an equimolar mixture through a nanocomposite MFI/alumina fibre after pretreatment at 673 K for 4 h. Conditions: temperature 300 K transfibre pressure 700 Pa.

As can be seen, the fibres synthesized show CO₂/H₂ separation factors up to 10 at 180 kPa average pressure and room temperature. The CO₂ mixture permeances reach the value 0.12 μmol·m⁻²·s⁻¹·Pa⁻¹ at 100 kPa at room temperature.

Separation of n-butane/H₂ and SF₆/N₂ Mixtures

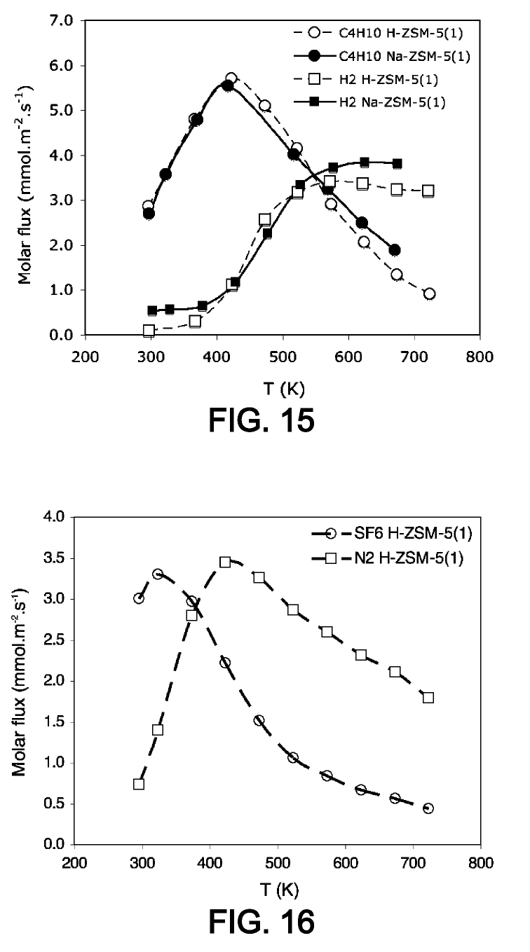

FIG. 15 shows the performance of the sample ZSM-5(1) towards separation of n-butane/H₂ equimolar mixtures before and after Na-exchange. (Conditions: retentate pressure, 104 kPa; transfibre pressure, 3.2 kPa; feed flow, 80 NmL/min (15 v/v. % n-butane, 15 v/v. % H₂); He flow (sweep gas), 52 NmL/min.)

The molar flux before and after Na-exchange is shown in the temperature range 300-723 K. In both cases, the n-butane flux shows a characteristic maximum at 430 K, as well as a decreasing trend for both fluxes at higher temperatures. The n-butane/H₂ separation factors, in favour to n-butane at low temperatures, are about 100 and 25, respectively, before and after Na-exchange.

FIG. 16 plots the evolution of SF₆ and N₂ molar fluxes with temperature in the separation of a SF₆/N₂ equimolar mixture for the hollow fibre H-ZSM-5 (1). Conditions: retentate pressure, 125 kPa; transfibre pressure, 0.4 kPa; feed flow, 80 NmL/min (15 v/v. % SF₆, 15 v/v. % N₂); He flow (sweep gas), 80 NmL/min.

As can be seen, despite the much higher kinetic diameter of SF₆ compared to N₂ (5.5 vs. 3.1 Å), the nanocomposite MFI hollow fibres prepared in this work permeate selectively SF₆ at room temperature, with separation factors reaching a value of 5. This result is mainly attributed to the much higher adsorption affinity of SF₆ on the MFI material than N₂ at low temperatures. This behaviour has also been verified in the case of MFI nanocomposites prepared on alumina tubes (not shown), but displaying lower fluxes. The observed evolution of SF₆ and N₂ fluxes with temperature suggests the absence of a significant amount of defects on the nanocomposite MFI material. Moreover, this result also suggests that the use of the SF₆/N₂ ratio as an indication of membrane quality should be carefully considered and only used at temperatures>700 K ensuring molecular sieving.

Separation of CO₂/N₂ Mixtures

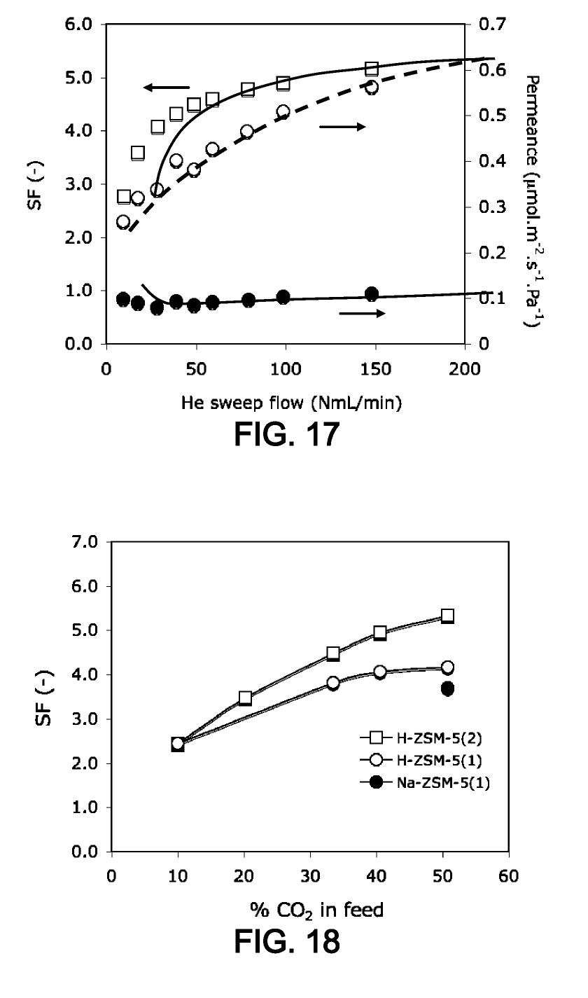

FIG. 17 shows the evolution of the CO₂/N₂ separation factor and CO₂ and N₂ mixture permeances with the He sweep gas flow for the sample H-ZSM-5 (1) in the separation of an equimolar CO₂/N₂ mixture. Conditions: retentate pressure, 168 kPa; transfibre pressure, 0.4 kPa.

As can be seen, the CO₂/N₂ separation factor and the corresponding fluxes tend to be unaffected at He flows higher than 150 NmL/min, ensuring lower enough partial pressures in the permeate. This flow has been hereinafter selected to carry out the gas separation measurements.

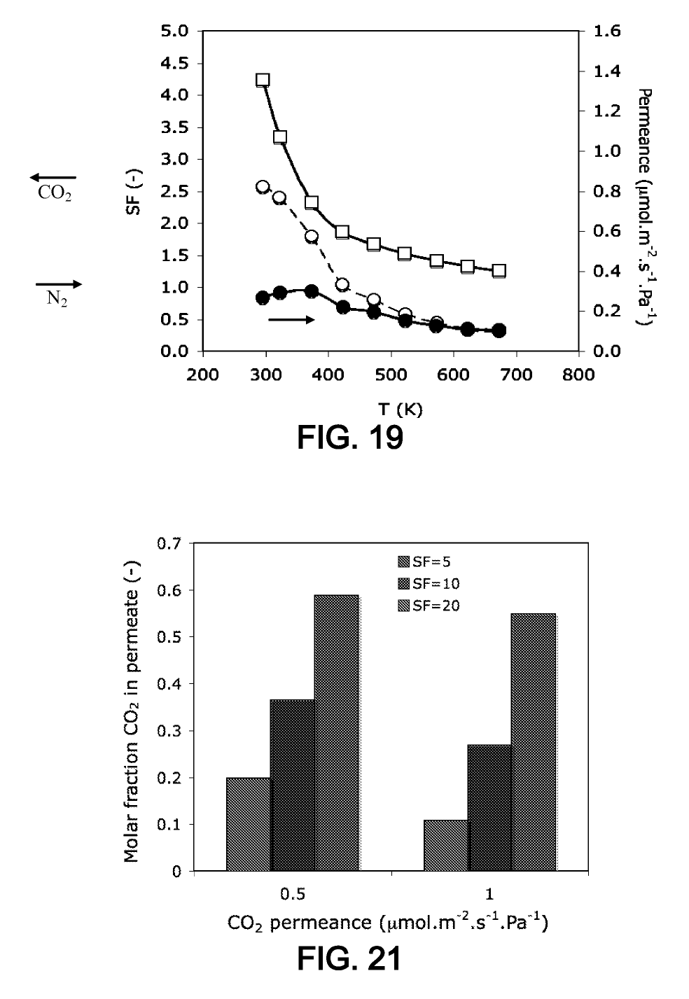

FIGS. 18 and 19 plot the evolution of the CO₂/N₂ separation factor in the separation of CO₂/N₂ equimolar mixtures, respectively, as a function of CO₂ feed composition (at room temperature), and temperature. As can be seen, the fibres synthesized in this work (H-form) show CO₂/N₂ separation factors up to 5 at room temperature, 168 kPa feed pressure and equimolar feed composition. The CO₂ mixture permeances reach a value about 1 μmol·m⁻²·s⁻¹·Pa⁻¹ at 168 kPa and room temperature. In the case of Na-exchanged fibres, no reliable result has been obtained due to the important contribution of He-counterdiffusion. However, according to the trends plotted in FIG. 10 for pure H₂ permeance, it seems reasonable that CO₂ and N₂ mixture permeances become promoted after Na-exchange due to increase of the pore size of the MFI material, keeping the CO₂/N₂ separation factors almost unchanged. This latter idea is sustained by the fact that the mixture permeance of both gases remains practically unchanged by increasing pressure beyond 101 kPa (not shown), and by the form of the CO₂ adsorption isotherms on H— and Na-MFI powder.

For these experiences, the conditions were: retentate pressure, 168 kPa; transfibre pressure, 0.4 kPa; temperature, 298 K; He sweep flow, 150 NmL/min.

### Discussion

MFI Growth

The weight uptake directly measured after calcination (˜100 mg MFI/g support) agrees fairly well with the values that can be computed from support macroporosity reduction, BET specific surface increase and Si/Al ratios obtained after MFI synthesis. First, the macroporosity of the support, as determined from Hg porosimetry (see FIG. 5) shows a cumulative pore volume decrease of about 40%, corresponding to about 0.09 cm³/g. This reduction would correspond to a deposition of 113 mg MFI/g support taking a MFI density of 1.7 g/cm³ and a microporosity of 30% (apparent density 1.2 g/cm³). This is in fairly good agreement with the values obtained from direct weight uptake measurement.

Second, the BET surface area of a crushed fibre shows an increase of 33−2.2=30.8 m²/g after synthesis. If we consider a BET surface area in the order of 1000 m²/g for MFI, as determined in our premises from pure MFI powder deposited at the bottom of the autoclave after synthesis, the computed weight uptake is about 110 mg MFI/g support. This value also matches the values obtained from direct weight uptake measurement and support macroporosity reduction. Moreover, the form of the N₂ adsorption/desorption curves on the crushed fibres after synthesis approaches a Type I isotherm, as expected for a material highly enriched in MFI microporous material.

Third, all these computed excesses are also similar to that deduced from Si concentration (4-5 wt. %, i.e. 10% wt. SiO₂) measured by elemental (ICP) analysis. Taking. The EDX analysis provide numbers in the same order of magnitude, but is much less precise.

Finally, in light of the results obtained from MS fittings to H₂ permeation, the equivalent MFI thickness to permeation (1 μm) accounts for a very low proportion of the total weight of the synthesized MFI material (about one hundredth). The remaining material should therefore be attributed to zeolite crystals blocking partially fibre macropores, but badly intergrown. This result reinforces the idea that most of the zeolitic material contributes only to a certain extent to pore-plugging, as can be inferred from the reduction of the mean pore size of the fibres from 0.46 to 0.26 μm provided by Hg porosimetry.

Nanocomposite Nature of MFI/alumina Fibres

The SEM micrographs (FIGS. 8 and 9) reveal that no film is formed on the top of the support. This has been confirmed by a local EDX analysis of the top view. In this zone, the Si concentration is similar to that observed on the bare fibre. In these zones, the Si/Al ratio is fairly constant over the thickness of the material. Taking into account the relative density of the host ceramic and that of MFI, as well as the porosity of the fibres (43%), the ratio observed (0.1-0.2) indicates an important proportion of pores filled by the zeolitic material.

Fibre Quality

Before calcination, no significant N₂ permeance was observed due to the presence of the structure directing agent blocking the zeolite pores. This result shows that only one synthesis cycle should be enough to build a defect-free membrane.

This is confirmed by the high n-butane/hydrogen separation factors obtained at low temperature.

Thermal Behaviour of Single Gas Permeance

The absolute permeance values of H₂ and N₂ through the MFI/alumina fibres at room temperature (see FIG. 11) are close to those found in MFI membranes. This result is opposite to the idea put forward by some authors that embedding the zeolite crystals into the support pores may lead to lower permeance values. In this case, the synthesis of very thin intergrown MFI nanocomposites in the macroporosity of the support, with equivalent thickness close to 1 μm, as computed from MS modelling, prevents the membranes from a sharp reduction of gas permeance.

Moreover, pure H₂ and N₂ fluxes show a continuous decrease with temperature in the range 273-723 K. This trend differs from that usually found in film-like MFI membranes (silicalite-1 and ZSM-5) grown on alumina and stainless steel supports, where H₂ and N₂ fluxes show a sharp increase over 400 K. In the case of permeation of light hydrocarbons and isobutene within film-like MFI membranes, this flux increase at higher temperatures is observed after passing though a maximum, in keeping with adsorption.

Therefore, pure H₂ and N₂ fluxes within the nanocomposite MFI/alumina fibres synthesized can be well described by the MS equation (Eq. 2), with no need to add an ‘activated diffusion’ term to account for flux increase at higher temperatures. This discrepancy between both configurations has been attributed to the reversible opening of intercrystalline pathways in films upon heating owing to the negative expansion coefficients of the MFI structure, something that is not allowed in the nanocomposite architecture.

Gas Separation

The n-butane/H₂ separation data presented in FIG. 14 are in excellent agreement with those experimentally determined by our group on nanocomposite MFI/alumina membranes. Butane shows a maximum ca. 430 K and the n-butane/H₂ separation factor shows a decreasing trend with temperature from a value of 27 at room temperature to 0.3 at 723 K. However, in the case of fibres, the pure gas permeance is ca. 3 times higher than those that are obtained through MFI tubular membranes. This difference might be attributed to a lower MFI thickness (equivalent) in the former case, as computed from fittings of nitrogen and hydrogen permeance data to the MS model (1 μm in fibres vs. 3 μm in tubular membranes for the same fitting parameters).

Moreover, as observed for nanocomposite MFI/alumina tubular membranes, MFI/alumina fibres do not show a flux increase for both gases at higher temperatures. Claim that this trend is opposite to that reported by Kapteijn et al. in “permeation behaviour of a silicalite-1 membrane” Catal. Today 25, (1995) 213, and many others on film-like MFI membranes, where n-butane and H₂ fluxes show a sharp increase over 500 K. Such increase at higher temperatures has also been observed in the separation of xylene mixtures within film-like MFI membranes grown on porous α-alumina and stainless steel supports. In the case of p-xylene, flux increase is observed above 480-573 K.

Finally, the results plotted in FIG. 14 reveal that the nanocomposite MFI/alumina fibres prepared in this work are useful for CO₂ separation. The separation factors obtained in this work (up to 10) are of the same order to those that can be achieved using film-like MFI-type zeolite membranes at similar experimental conditions. However, these fibres offer higher permeances as well as much higher module surface/volume ratios.

### Conclusion

Nanocomposite MFI/alumina hollow fibres with a negligible amount of intercrystalline defects and high gas permeance at room temperature have been successfully synthesized using the pore-plugging approach. In this nanocomposite architecture, grain boundaries that could limit selectivity are less important than in film-like structures.

These results enable to scale up the fibre preparation process as an aim to obtain fibre bundles easy to scale-up to carry out separations of industrial interest, in particular CO₂ from flue gases. The advantage of such systems do not only arises from its nanocomposite nature, which allows selective separations at high temperature, but also on their very high surface/volume ratios when compared to conventional tubular MFI membranes (even of multichannel forms). The use of such systems might allow a reduction in size and cost of the permeating module. In turn, this might be used for CO₂ removal in numerous processes.

Technico-economical Feasibility of a Membrane-based Unit for CO₂ Capture in Heavy Vehicles

In light of the results above presented, we discuss in this section the suitability of the hollow-fibres developed in our laboratory for on-board CO₂ capture in mobile sources in terms of energy economy and CO₂ emission reduction. We also provide some insight into the material characteristics (fluxes and selectivities) that would be required to conceive a ‘realistic’ membrane-based unit for CO₂ capture in heavy vehicles (such as trucks, trains, boats, . . . >3500 kg). Ideally, the CO₂ capture system should occupy a low volume and allow the removal of at least 75% of the CO₂ in the exhaust gas with a purification of 0.95 in the permeate without a significant energy over consumption (<15% of the utile power).

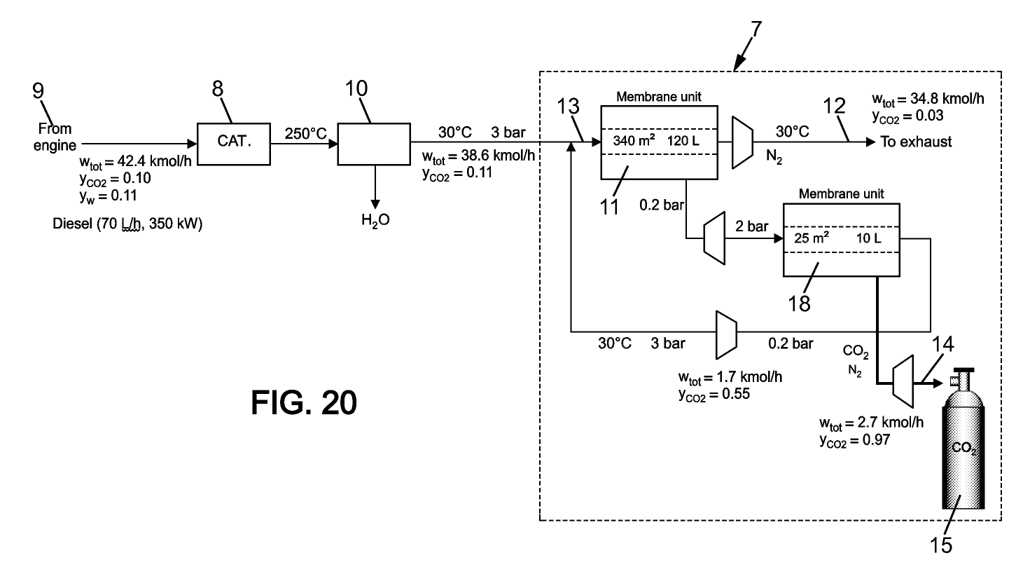

FIG. 20 shows the scheme of the hollow-fibre-based unit 7 for in situ CO₂ capture in heavy vehicle (the heat exchangers are not included for simplicity). Input hollow-fibre properties: SF_{CO2/N2}=20 (irrespective of the retentate composition, T=30° C.), CO₂ permeance=0.5 μmol.m⁻².s⁻¹.Pa⁻¹.

Description of the Unit and Modelling

The general scheme of the concept proposed is depicted in FIG. 20. The exhaust gas emitted from a vehicle 9 after catalytic CO and NOₓ reduction 8 mainly consists of a mixture of CO₂, H₂O and N₂ at the approximate molar ratio 10:10:80 and at a temperature and pressure of 250° C. and 303 kPa, respectively. The solution here proposed would involve a first step of water removal 10 and cooling down 10 to 30° C. to optimize the permeation performance of the zeolite hollow fibres. The dried gas 13 (molar composition CO₂:N₂ 11:89 (almost 1% H₂O) would then be submitted to a hollow-fibre unit 11 to capture at least 70%, preferably at least 75% (molar basis) of the CO₂, and then evacuated an exhaust gas 12 highly enriched in N₂. Taking into account the low CO₂ concentration in the gas at the entry of the hollow-fibre unit, the permeate should be kept under primary vacuum (<30 kPa) to enhance the CO₂ driving force across the hollow fibres without increasing dramatically the retentate pressure. Finally, the CO₂ concentrated in the permeate would be compressed 14 at supercritical conditions at a pressure up to 100 bar, or liquefied at a pressure up to 200 bar, at room temperature to be in situ stored in high-pressure reservoirs 15 in the vehicles and further removed.

Assuming a quasi-isothermal regime, a hollow-fibre unit for CO₂ capture in vehicles can been modelled by a microscopic mass balance of CO₂ and N₂ both in the lumen and in the permeate sides of the fibres. For the sake of simplicity, plug-flow regimes have been assumed to describe the hydrodynamics of the retentate and permeate zones. The pressure drop along the axial position inside the membrane tubes has been modelled by the Ergum Equation. The criteria for plug-flow regime in tubular systems have been obtained from Rase. At steady state, the set of Eqs. 1-3 is obtained
Microscopic mass balance (i=CO₂, N₂)

$$- \frac{\partial ( {w}_{R} {x}_{i} )}{{A}_{b} \partial z} - {N}_{i} {a}_{m} = 0 \qquad ( Eq . 1 )$$

Permeation (i=CO₂, N₂)

$$- {N}_{i} {a}_{m} = \frac{\partial ( {w}_{P} {y}_{i} )}{{A}_{b} \partial z} \qquad ( Eq . 2 )$$

Pressure drop (Ergum equation)

$$\frac{\partial {P}_{o}}{\partial z} = 150 \frac{{( 1 - {ɛ}_{b} )}^{2}}{{ɛ}_{b}^{3}} \frac{{μ}_{L} {u}_{o}}{{D}_{p}^{2}} + 1.75 \frac{( 1 - {ɛ}_{b} )}{{ɛ}_{b}^{3}} \frac{{ρ}_{L} {u}_{o}^{2}}{{D}_{p}} \qquad ( Eq . 3 )$$

Boundary conditions: z=0→xᵢ=x_{i,in}, yᵢ=y_{i,in}, Pₒ=P_{o,in}.

The CO₂ and N₂ permeances and CO₂/N₂ separation factors have been taken from FIG. 19. In addition, different values of gas permeances and separation factors have also been tested to evaluate the effect of both parameters on the final performance of the unit. The model has been solved numerically through discretization using finite differences. The number of intervals (200 or more) has been chosen to avoid any dependence of the simulation results on the discretization. The logarithmic partial pressure differences along the unit have been approached to linear differences. The calculations have been performed for a vehicle of 350 kW (˜400 CV) utile power with a consumption of 70 L/h of a diesel fuel with molecular formula C₁₁H₂₄. In these calculations, a number of 50000 hollow fibres of 1.65 mm outer diameter, 1.44 mm inner diameter and 1.5 m length in the first unit 11, and 4000 in the second one 18, have been considered, accounting, respectively, for a hollow-fibre active surface of 350 and 25 m². The volume of each unit, 240 and 20 L, respectively, has been computed as twice the volume occupied by the fibres take into account explicitly the spacing between the fibres. Claim that, using conventional tubular MFI membranes, the total volume of the units would be higher than 1000 L (925+75 L) for the same total separation surface. The properties of the exhaust gas and the input data used hereinafter for the modelling are summarized in Table 2.

Number of Hollow-fibre Units

Depending on the separation properties of the hollow fibres, a cascade of two and even more units might be considered to concentrate the CO₂ to a molar fraction of at least 0.95 in the permeate to reduce the liquefaction costs. The maximum CO₂ purity that can be attained in the permeate is directly related to the separation factor of the fibres, while the CO₂ permeance influences the required separating surface of each unit.

TABLE 2
Properties of the exhaust gas at the
inlet of the hollow-fibre unit and input
data for modelling.

| | |
|---|---|
| Parameter | Value |

| T [° C.] | 30 | |
|---|---|---|
| P [kPa] | 303 | |
| Molar composition (CO₂:N₂)* | 11:89 | |
| Inter-fibre gas flow [kmol/h]* | 37.6 | |
| Pₚₑᵣₘ [kPa] | <20 | |
| uₒ (lumen) [m/s] | 15 | |
| D_{bnt} [mm] | 1.44 | |
| aₘ [m² · m⁻³] | 3000 | |
| Active surface [m²] | 350 | (1^{st} unit) |
| | 25 | (2^{nd} unit) |
| Unit volume [L] | 240 | (1^{st} unit) |
| | 20 | (2^{nd} unit) |

*Values computed for a heavy vehicle with a 70 L/h-consumption of a diesel fuel with composition C₁₁H₂₄.

FIG. 21 show the evolution of the molar fraction of CO₂ in the permeate of a hollow-fibre unit with the separation factor for a CO₂ permeance of 0.5 and 1.0 μmol.m⁻².s.Pa⁻¹. Unit dimensions: Δx=1.0 cm; L=20.6 m; retentate pressure=303 kPa; permeate pressure=20 kPa.

Our calculations reflect that, using the input data in Table 1 and for only one separation unit, a CO₂ molar fraction up to 0.60 could be achieved in the permeate for a CO₂/N₂ separation factor of 20 invariable with the retentate composition (see FIG. 21). This result suggests that at least a cascade of two units as depicted in FIG. 20 (i.e. the permeate of the first unit feeds the second one) might be used to attain a CO₂ purity of 0.95.

To gain more insight into this point, Table 3 summarizes the main results obtained for CO₂ recuperation and purity, as well as the related energy over consumption and autonomy, as a function of the CO₂/N₂ separation factor and CO₂ permeance of the fibres, that would be obtained for a system constituted by a cascade of two hollow-fibre units and characterized by the input data listed in Table 2.

TABLE 3
Simulated performance of a CO₂ capture
system in a heavy vehicle (70-L/h consumption) based
on a cascade of two hollow-fibre units as a function
of the CO₂/N₂ separation factor and CO₂ permeance.
Input data as in Table 2.

| | Separation factor | | | | | |
|---|---|---|---|---|---|---|
| CO₂ permeance | 5 | | 10 | | 20 | |
| [μmol · m⁻² · s⁻¹ · Pa⁻¹] | 0.5 | 1.0 | 0.5 | 1.0 | 0.5 | 1.0 |
| CO₂ exhaust gas | 0.01 | <0.01 | 0.02 | <0.01 | 0.03 | 0.02 |
| (outlet) [—] | | | | | | |
| CO₂ recuperation | 86 | >99 | 83 | 97 | 74 | 84 |
| [%] | | | | | | |
| CO₂ purity [—] | 0.80 | 0.75 | 0.92 | 0.88 | 0.97 | 0.95 |
| Overconsumption | 31.3 | 55.7 | 20.9 | 30.0 | 13.7 | 14.2 |
| [%]* | | | | | | |
| Autonomy [h]^{†} | 8.6 | 4.7 | 7.9 | 5.1 | 8.0 | 7.2 |

*Value computed over a utile power of 350 kW including gas compression and CO₂ liquefaction
^{†}Value computed for a CO₂ storage volume of 750 L

As can be inferred from Table 3, irrespective of the CO₂ permeance, only a CO₂/N₂ separation factor higher than 20 would allow the desired purification of the permeated CO₂ up to the target molar fraction of 0.95 with an energy over consumption lower than 15%, for example about 12%, and an autonomy about 8 h to fill 750 L of CO₂ storing reservoirs (kept at 200 bar and room temperature and under supercritical conditions).

This would correspond to an autonomy of 17 h to fill a 2.5 m³ reservoir of CO₂ at supercritical condition of 100 bar and room temperature.

Of course, higher CO₂ permeances for this given separation factor would allow a higher CO₂ recuperation from the inlet exhaust gas, increasing from 74% to 84% when rising the CO₂ permeance from 0.5 to 1.0 μmol.m⁻².s.⁻¹Pa. The energy over consumption increases dramatically with the reduction of the CO₂/N₂ separation, reaching a value higher than 60% in the case of separation factors of 5 and CO₂ permeances of 1.0 μmol.m⁻².s⁻¹.Pa⁻¹. This result is mainly due to the increase of the recirculation stream mass flow, involving in its turn an increase of the energy demands ascribed to the compression from 20 to 303 kPa.

Table 4 lists in more detail the output data obtained for the cascade of 2 units at the given CO₂/N₂ separation factor of 20 and CO₂ permeance of 0.5 μmol.m⁻².s⁻¹.Pa⁻¹ using the input data listed in Table 2.

TABLE 4
Output data obtained from the
simulations of a cascade of 2 units using the input
data in Table 2.

| Variable | Value |
|---|---|
| CO₂ recovered [%] | 74 |
| CO₂ purity for liquefaction [—] | 0.97 |
| CO₂ molar fraction in exhaust | 0.03 |
| gas [—] | |
| Overconsumption [%]* | 13.7 |
| Autonomy [h]^{†} | 8 |
| Effective volume [m] | 120 (1^{st} unit) |
| | 10 (2^{nd} unit) |
| Number of fibres | ~50000 (1^{st} unit) |
| | ~4000 (2^{nd} unit) |
| Hydrodynamics [21] | |
| L/D_{b} [—] | 14000 > 100 (1^{st} |
| | unit) |
| | 4500 > 100 (2^{nd} |
| | unit) |
| Pressure drop [kPa] | <50 (1^{st} unit) |
| | <15 (2^{nd} unit) |

*Value computed over a utile power of 350 kW including gas compression and CO₂ liquefaction.
^{†}Value computed for a CO₂ storage volume of 750 L

Table 3 also reflects the suitability of the plug-flow regime to describe the hydrodynamics inside the hollow fibres, since the condition L/D_{b}>100 is fulfilled. The pressure drop along the fibres would be <50 kPa in the former unit and <15 kPa in the second one.

Suitability of the Hollow Fibres Prepared in this Study

As has been above stated, the hollow fibres prepared in this study offer high CO₂ permeances that can be even increased by cation exchange. This result seems promising in terms of volume economy, since these permeances are about an order of magnitude higher than the values that can be conventionally achieved using film-like membranes. The fibres prepared in this study offer interesting CO₂/N₂ separation factors at low CO₂ feed compositions (the maximum value that can be reached on current trends is about 3 at a CO₂ molar concentration of 10%). According to Table 2, this separation factor would translate into a final low CO₂ purity and a high energy over consumption using a cascade of two membrane units. A third unit might help improving the molar fraction of the permeated CO₂, although it should also be balanced with the energy over consumption due to the energy demands ascribed to gas compression of the retentate stream of the third unit being recirculated to the second one.

Conclusions and Perspectives

High-flux MFI-alumina hollow fibres with a negligible amount of intercrystalline defects and partially selective to CO₂ at room temperature have been successfully synthesized using the pore-plugging approach. Compared to film-like membranes, the nanocomposite architecture of this material, involving a very low effective thickness, allows higher permeances. The permeance can be even promoted by cation exchange.

Although the separation factors obtained in this study remain still low and have therefore to be optimized, the high fluxes obtained on these materials make them promising to embark on realistic applications for in situ CO₂ capture in mobile sources, notably in heavy vehicles at reasonable energy over consumption and autonomy. In addition, the use of hollow fibres instead of conventional tubular membranes might allow a reduction about 1 order of magnitude of the separation unit volume.

A last point is the handling of water vapour. Drying the exhaust gas is of utmost importance to prevent the microspores of the MFI material from being partially blocked by water during operation, reducing therefore drastically the gas permeance. Water condensation is of course an option, using, for example, a radiator. However, condensation at very low temperatures to remove water to trace concentrations could involve relevant energy costs. To avoid this shortcoming, the development hydrophilic membranes (e.g. A-type zeolite for selective water removal, or of hydrophobic ceramic hollow-fibres and selective to CO₂ (e.g. hydrophobic MCM or polymer membranes functionalized with amine groups) could be a good option to dry and pre-concentrate CO₂ at the same time in a first unit. The permeated gas across this unit partially enriched with CO₂ could be then submitted to a second unit constituted by MFI-based hollow fibres to purify CO₂ to the required target concentration.

The transport field accounts itself for more than 25% of CO₂ emissions in France. Unlike other European countries, this French specificity in the CO₂ emission pattern is mainly ascribed to the great development of the nuclear field as energy vector. Therefore, the design of research strategies directed to a severe reduction of CO₂ emissions in mobile sources, especially in heavy vehicles, seems imperative. Taking into account that alternative propulsion technologies based on hydrogen energy like fuel cells are hardly expected to be competitive at short term, direct post-combustion CO₂ capture in mobile sources could be a good option to reduce such emissions. The technological solution for CO₂ capture in vehicles should not only allow for high CO₂ recovery from exhaust gases at high purity (>95%), but also involve low volume and modest over consumption (<15%). To fulfil on these requirements, we propose in this study and for the first time the use of high-flux nanocomposite MFI-alumina hollow-fibre membranes recently developed in our laboratory for in situ CO₂ capture in mobile sources. A critical discussion is provided about the technico-economical feasibility of a unit for direct CO₂ capture and liquefaction in heavy vehicles using conventional diesel propulsion standards.

1. A membrane comprising:
a hollow support having a plurality of pores
an active phase comprising a gaz-selective capting material embedded into the pores.

2. The membrane of claim 1, wherein the support is made of a ceramic material.

3. The membrane of claim 2, wherein the ceramic is alumina.

4. The membrane of claim 1, wherein the gaz-selective capting material comprises, preferably is made of, zeolite crystals.

5. The membrane of claim 4, wherein the zeolite is MFI.

6. The membrane of claim 1, wherein some pores, preferably all pores, have a size between 0.3 and 0.4 micrometers (μm).

7. The membrane of claim 1, having no surface film of gaz-selective material on top the support.

8. The membrane of claim 1, wherein the support is cylindrical, has a diameter of over 1 millimeter (mm), preferably over 1.7 mm, and/or a length of over 15 cm, preferably over 23 cm.

9. The membrane of claim 1, wherein the support is symmetrical.

10. The membrane of claim 1, wherein the support has a mean wall thickness of less than 500 μm, preferably less than 230 μm.

11. The membrane of claim 1, wherein the support has an average crossing pore size of less than 0.2 μm.

12. A gas separation apparatus comprising at least one membrane according to claim 1, a gas intake fluidly connected to one end of the support, and adapted to receive a gas mixture, of at least N gazes, N>1, wherein the gaz-selective capting material is selective to at least 1 and at most N-1 gazes of the gas mixture.

13. An apparatus according to claim 12, comprising a pressurizing device adapted to set a trans-support wall differential pressure, preferably of between 0.1 and 1 kiloPascals (kPa).

14. An apparatus according to claim 12, comprising a pressurizing device adapted to generate an in-flow of gas having a pressure, preferably of between 50 and 500 kPa.

15. Use of the membrane according to claim 1, for gas separation.

16. The use of claim 14, wherein a gas to be separated from another gas is CO₂.

17. The use of claim 14, wherein a gas to be separated from another gas is butane.

18. The use of claim 16, wherein the other gas is N₂.

19. A method of manufacturing a membrane comprising embedding an active phase comprising gaz-selective capting material into pores of a hollow support.

20. Method according to claim 19, wherein embedding comprises pore-plugging synthesis.

21. Method according to claim 19, wherein the hollow support is manufactured by wet spinning.

22. Method according to claim 19 wherein embedding comprises at least one of:
mixing a structure directing agent and a silica source,
submitting the support to hydrothermal synthesis in an autoclave comprising the mixing,
calcinating the support.

23. A device adapted to be fixed onto an automotive vehicle having a combustion engine, said device comprising a separating unit adapted to receive an exhaust gas from said engine, and to separate CO₂ from said exhaust gas, said separating unit comprising at least one membrane comprising:
a hollow support having a plurality of pores,
an active phase comprising a gaz-selective capting material embedded into the pores.

24. The device of claim 23 further having a cooling unit adapted to cool said exhaust gas prior to insertion into said separating unit.

25. The device of claim 23, further comprising a liquefying device adapted to liquefy permeated CO₂ gas.

26. The device of claim 23, further comprising a device adapted to place permeated CO₂ in supercritical state.

27. The device of claim 23, wherein the membrane has a surface of over 300 m², preferably over 350 m², in a volume of less than 300 L, preferably less than 240 L.

28. The device of claim 23, wherein the separating unit comprises at least a plurality of cascaded membranes, the intake of a further membrane being fluidly connected to the permeate of the previous membrane.

29. The device of claim 23, comprising pressurizing mean adapted to generate a pressure of the permeate lower than 50 kPa, and preferably lower than 30 kPa.

30. The device of claim 23, wherein at least one membrane has a separation factor of at least 10, and preferably at least 20.

31. A membrane for a device according to claim 23, further comprising cations such as sodium (Na) in the zeolite structure.

32. A membrane for a device according to claim 23, wherein the support is hydrophobic.

33. An automotive vehicle having a combustion engine and a device or a membrane according to claim 23.
